(19) United States
(12) Patent Application Publication
(10) Pub. No.: US 2025/0222613 A1
(43) Pub. Date: Jul. 10, 2025

(54) CUTTING APPARATUS USING MULTI-WIRE AND CONTROL METHOD THEREOF

(71) Applicant: HANWHA PRECISION MACHINERY CO., LTD.

(72) Inventors: Min Su KIM, Changwon-si (KR); Hong Ju LEE, Changwon-si (KR)

(73) Assignee: HANWHA PRECISION MACHINERY CO., LTD., (omitted)

(21) Appl. No.: 19/088,581

(22) Filed: Mar. 24, 2025

Related U.S. Application Data
(63) Continuation of application No. PCT/KR2023/012312, filed on Aug. 21, 2023.

(30) Foreign Application Priority Data
Nov. 9, 2022 (KR) 10-2022-0148504

(51) Int. Cl. B26D 5/08; B26D 1/00; B26D 1/48; B26D 1/50

(52) U.S. Cl. CPC B26D 5/086; B26D 1/0006; B26D 1/48; B26D 1/50; B26D 2001/008

(57) ABSTRACT

A cutting apparatus includes a main roller, a main motor configured to rotate the main roller, a plurality of adjusting rollers spaced apart from the main roller, a plurality of sub-motors respectively connected to the plurality of adjusting rollers and configured to respectively rotate the plurality of adjusting rollers, a plurality of cutting wires wound around the main roller and the plurality of adjusting rollers, and a controller configured to control the main motor and the plurality of sub-motors such that a surface speed of the main roller is substantially the same as surface speeds of the plurality of adjusting rollers.

### CROSS-REFERENCE TO RELATED APPLICATION(S)

This application is a continuation of International Application No. PCT/KR2023/012312, filed on Aug. 21, 2023, in the Korean Intellectual Property Receiving Office, which is based on and claims priority to Korean Patent Application No. 10-2022-0148504, filed on Nov. 9, 2022, in the Korean Intellectual Property Office, the disclosures of which are incorporated herein by reference in their entireties.

### BACKGROUND

### 1. Field

Example embodiments of the disclosure relate to a cutting apparatus using a multi-wire and a control method thereof.

### 2. Description of Related Art

Silicon substrates, sapphire substrates, quartz substrates (sub-parts), and silicon parts (sub-parts) used in a semiconductor process are generally used by being cut from large-sized specimens using multi-wires.

For example, in the case of a silicon substrate, an ingot having as large a diameter as possible is cut to create individual wafers, and integrated circuit elements are mass-produced on the wafers, and the main method of cutting an ingot into a wafer shape is using a multi-wire.

The cutting wire may be a high carbon steel wire uniformly coated with very small diamonds of about 10 μm to 120 μm.

FIG. 1 is a diagram illustrating an example of a cutting apparatus using a related-art multi-wire.

That is, the apparatus illustrated in FIG. 1 is an apparatus for cutting an ingot of polycrystalline silicon or single crystalline silicon into thin pieces.

Main components of the cutting apparatus include a pair of rollers 3, a wire 5, a motor 4 for rotating the pair of rollers 3 on which the wire is wound, and a specimen transporter 2 for transporting an specimen 1 (e.g., an ingot).

The cutting apparatus of FIG. 1 uses a cutting wire connected in one line.

Since the cutting apparatus that uses a multi-wire continuously connected in one line needs to complete a cutting operation before the specimen touches the wires of another layer (i.e., opposite wires) when the cutting is made in one layer of the two layers of wires exposed between two rollers, a cutting distance is smaller than a diameter of the roller.

As the cutting distance is smaller than the diameter of the roller, a size of the specimen that may be cut is limited by the distance between the two rollers and the diameter of the roller, and thus, larger rollers need to be used to cut larger specimens.

That is, in order to process a specimen with a height of 1 m, a height of the cutting apparatus needs to be 1 m or more in addition to the 1 m where the specimen is placed.

In particular, a space occupied by the entire facility requires more than twice the size of the specimen. Accordingly, there is a need for a method to utilize the advantages of cutting apparatus using the wire without significantly increasing the space occupied by the entire facility.

Furthermore, in a cutting apparatus illustrated in FIG. 1, all wires move in one direction according to a rotation direction of the roller and apply a cutting force to the specimen.

In this case, if the pair of rollers do not have the same diameter but have different diameters for processing reasons, a load is generated on a motor due to a difference in the outer diameters of the rollers because the pair of rollers rotates at the same speed. As such, a load is directly transmitted to the wires wounded on the rollers. Therefore, problems occur in which the wires vibrate or are damaged.

In addition, even if the pair of rollers is precision-machined, a difference in diameter may occur, and if the pair of rollers continuously rotates at the same speed, the load on the motor gradually increases and the degree to which the wires vibrate or are damaged increases. As a result, efficiency of the motor is greatly reduced, making it difficult to efficiently operate the equipment, and a higher cutting force could not be provided because a linear speed of the wire could not be increased.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided are a cutting apparatus using a multi-wire that may rotate a wire at the same speed even if diameters of a plurality of rollers are different from each other, and a control method thereof.

Further provided are a cutting apparatus using a multi-wire that may include at least three or more small-sized rollers and thus may cut an ingot having a large volume while reducing a load applied to a motor connected to the rollers, and a control method thereof.

Further provided are a cutting apparatus using a multi-wire in which a motor may be connected to one roller and the roller may independently rotate such that speeds of a plurality of rollers may be individually controlled, which may reduce a load applied to the motor, and a control method thereof.

Further provided are a cutting apparatus using a multi-wire that may rotate the wire at the same speed even if diameters of a plurality of rollers are different, which may reduce a load on a motor, and thus minimizing vibration and damage to the wire, and a control method thereof.

Further provided are a cutting apparatus using a multi-wire that capable of providing a high cutting force by increasing a linear speed of the wire as the wire stably rotates, and a control method thereof.

Additional aspects will be set forth in part in the description which follows and, in part, will be apparent from the description, or may be learned by practice of the presented embodiments.

According to an aspect of the disclosure, a cutting apparatus may include a main roller, a main motor configured to rotate the main roller, a plurality of adjusting rollers spaced apart from the main roller, a plurality of sub-motors respectively connected to the plurality of adjusting rollers and configured to respectively rotate the plurality of adjusting rollers, a plurality of cutting wires wound around the main roller and the plurality of adjusting rollers, and a controller configured to control the main motor and the plurality of sub-motors such that a surface speed of the main roller is substantially the same as surface speeds of the plurality of adjusting rollers.

The controller may be further configured to control the main motor and the plurality of sub-motors at an initial command speed.

Based on an output torque of at least one of the plurality of sub-motors corresponding to the initial command speed being smaller or greater than an output torque of the main motor corresponding to the initial command speed, the controller may be configured to control the at least one of the plurality of sub-motors at a changed command speed.

Based on the output torque of the at least one of the plurality of sub-motors being greater than the output torque of the main motor, the changed command speed may be slower than the initial command speed and, based on the output torque of the at least one of the plurality of sub-motors being smaller than the output torque of the main motor, the changed command speed may be faster than the initial command speed.

The controller may include a compensation controller configured to determine a compensation speed value for the output torque of the at least one of the plurality of sub-motors and determine the changed command speed by adding or subtracting the compensation speed value to or from the initial command speed.

The compensation controller may be further configured to provide the changed command speed to the at least one of the plurality of sub-motors such that the output torque of at least one of the plurality of sub-motors becomes substantially the same as the output torque of the main motor.

Based on the output torque of the at least one of the plurality of sub-motors corresponding to the initial command speed being smaller or greater than the output torque of the main motor corresponding to the initial command speed, the controller may be configured to determine that a diameter of the main roller is different from a diameter of at least one of the plurality of adjusting rollers.

The main roller and at least one of the plurality of adjusting rollers may have different diameters.

Based on a diameter of at least one of the plurality of adjusting rollers being greater than the diameter of the main roller, the controller may be configured to a sub-motor of the plurality of sub-motors connected to the at least one of the plurality of adjusting rollers at a changed command speed that is slower than a command speed of the main motor and, based on the diameter of the at least one of the plurality of adjusting rollers being smaller than the diameter of the main roller, the controller may be configured to control the sub-motor connected to the at least one of the plurality of adjusting rollers at a changed command speed that is faster than the command speed of the main motor.

The plurality of adjusting rollers may include two adjusting rollers and the main roller and the two adjusting rollers may be disposed such that a center of rotation of the main roller and the two adjusting rollers forms an inverted triangle.

According to an aspect of the disclosure, a control method of a cutting apparatus, the cutting apparatus including a main roller, a main motor configured to rotate the main roller, a plurality of adjusting rollers, a plurality of sub-motors configured to respectively rotate the plurality of adjusting rollers, and a plurality of cutting wires wound around the main roller and the plurality of adjusting rollers, may include controlling the main motor and the plurality of sub-motors at an initial command speed and controlling speeds of the plurality of sub-motors such that a surface speed of the main roller is substantially the same as surface speeds of the plurality of adjusting rollers.

The controlling the speeds of the plurality of sub-motors may include comparing an output torque of the main motor and an output torque of at least one of the plurality of sub-motors, and controlling the at least one of the plurality of sub-motors at a changed command speed based on the output torque of the at least one of the plurality of sub-motors being different from the output torque of the main motor.

The controlling the speeds of the plurality of sub-motors may include controlling the at least one of the plurality of sub-motors at the initial command speed based on the output torque of the at least one of the plurality of sub-motors being substantially the same as the output torque of the main motor.

Based on the output torque of the at least one of the plurality of sub-motors being greater than the output torque of the main motor, the changed command speed may be slower than the initial command speed and, based on the output torque of the at least one of the plurality of sub-motors being smaller than the output torque of the main motor, the changed command speed may be faster than the initial command speed.

The controlling of the at least one of the plurality of sub-motors at the changed command speed may include determining a compensation speed value for the output torque of the at least one of the plurality of sub-motors and determining the changed command speed by adding or subtracting the compensation speed value to or from the initial command speed.

The controlling of the at least one of the plurality of sub-motors at the changed command speed may include providing the changed command speed to the at least one of the plurality of sub-motors such that the output torque of the at least one of the plurality of sub-motors becomes substantially the same as the output torque of the main motor.

The comparing the output torque of the main motor and the output torque of the at least one of the plurality of sub-motors may include, based on the output torque of the at least one of the plurality of sub-motors corresponding to the initial command speed being smaller or greater than the output torque of the main motor corresponding to the initial command speed, determining that a diameter of the main roller is different from a diameter of at least one of the plurality of adjusting rollers.

The main motor, the plurality of sub-motors, and the plurality of cutting wires, the main roller and the plurality of adjusting rollers may have different diameters.

The controlling of speeds of the plurality of sub-motors may include, based on a diameter of the at least one of the plurality of adjusting rollers being greater than a diameter of the main roller, controlling a sub-motor of the plurality of sub-motors connected to the at least one of the plurality of adjusting rollers at a changed command speed that is slower than a command speed of the main motor, and based on the diameter of the at least one of the plurality of adjusting rollers being smaller than the diameter of the main roller, controlling the sub-motor of the plurality of sub-motors connected to the at least one of the plurality of adjusting rollers at a changed command speed that is faster than the command speed of the main motor.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a view illustrating an example of a cutting apparatus using a related-art multi-wire;

FIG. 2 is a illustrating a cutting apparatus using a multi-wire according to an embodiment of the present disclosure; and

FIGS. 3 and 4 are flowcharts illustrating control methods of a cutting apparatus using a multi-wire according to an embodiment of the present disclosure.

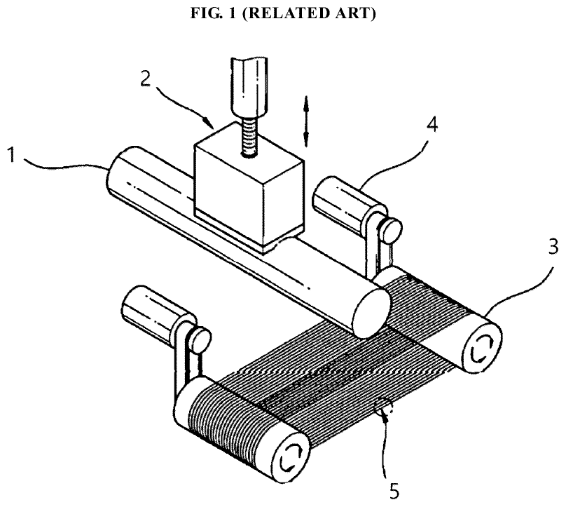

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

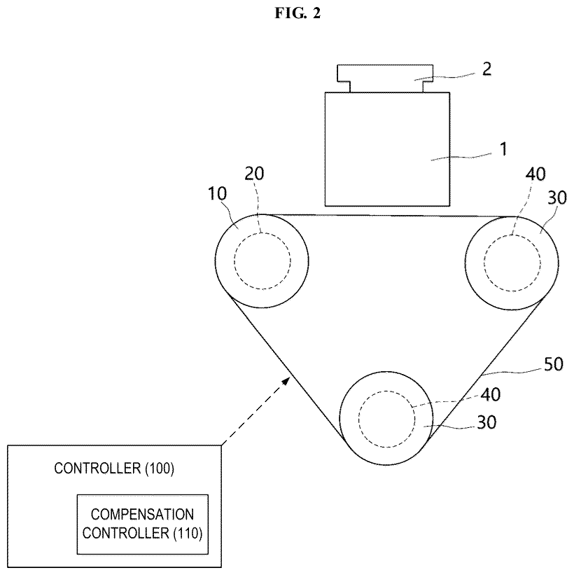

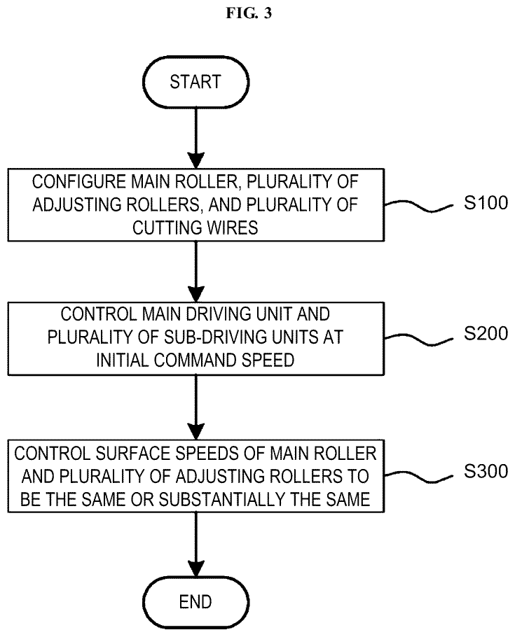

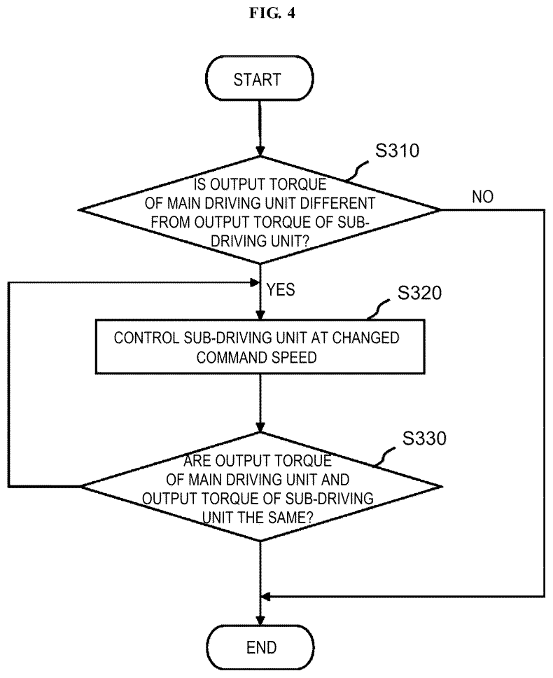

FIG. 2 is a diagram illustrating a cutting apparatus using a multi-wire according to an embodiment of the present disclosure. FIGS. 3 and 4 are flowcharts illustrating control methods of a cutting apparatus using a multi-wire according to an embodiment of the present disclosure.

As illustrated in FIGS. 2 to 4, a cutting apparatus using a multi-wire according to an embodiment of the present disclosure may include a main roller 10 that rotates according to the driving of a main motor 20, at least one adjusting roller 30 disposed to be spaced apart from the main roller 10 and independently rotating according to the driving of at least one sub-motor 40 each connected thereto, a plurality of cutting wires 50 wound around the main roller 10 and at least one adjusting roller 30, and a controller 100 that controls the main motor 20 and at least one sub-motor 40 such that surface speeds of the main roller 10, which rotates a cutting wire 50, and the at least one adjusting roller 30 are the same or substantially the same.

The cutting apparatus using the multi-wire according to an embodiment of the present disclosure may include a plurality of rollers 10 and 30, a plurality of motors 20 and 40, a plurality of cutting wires 50, and a controller 100.

The plurality of rollers 10 and 30 may include one main roller 10 and at least one adjusting roller 30 and are disposed to be spaced apart from each other such that a cutting wire 50, which will be described later, is wound.

The plurality of rollers 10 and 30 have grooves formed along circumferences such that a plurality of cutting wires 50 are positioned on each outer peripheral surface, and the plurality of cutting wires 50 are inserted into the grooves to prevent interference.

The main roller 10 and the at least one adjusting roller 30 may be generally configured to have the same or substantially the same diameter, but the main roller 10 and the at least one adjusting roller 30 may have slightly different diameters depending on processing errors, and may have different diameters depending on a size of a specimen 1.

The main roller 10 and the at least one adjusting roller 30 may be each connected to the motors 20 and 40 so as to rotate at individual speeds, and the motors 20 and 40 may include one main motor 20 and at least one sub-motor 40.

The main roller 10 may be connected to the main motor 20 and rotate according to the driving of the main motor 20, and may rotate at an initially input initial command speed before an external operation is input. In this case, the initial command speed may be a set speed input by an operator to obtain a certain cutting force and may be changed by the operator.

At least one adjusting roller 30 may be disposed to be spaced apart from the main roller 10, and may be each connected to at least one sub-motor 40 to independently rotate according to the driving of the sub-motor 40.

In addition, at least one adjusting roller 30 may initially rotate at the initial command speed and a speed thereof may be then changed.

The plurality of cutting wires 50 are wound around the main roller 10 and at least one adjusting roller 30, and as the main roller 10 and the at least one adjusting roller 30 rotate according to the rotation of the main motor 20 and the at least one sub-motor 40, the cutting wires 50 are transported, which may allow the specimen 1 to be cut.

That is, when the plurality of rollers 10 and 30 continue to rotate in a predetermined direction, the plurality of cutting wires 50 are also continuously transported, and as a result, the plurality of cutting wires 50 may cut the specimen 1.

In this case, when the plurality of rollers 10 and 30 includes two rollers including one main roller 10 and one adjusting roller 30, the size of the rollers 10 and 30 needs to be greater than the size of the specimen 1 to cut the specimen 1.

For this reason, the plurality of rollers 10 and 30 according to an embodiment of the present disclosure may be configured to include one main roller 10 and a plurality of adjusting rollers 30.

In particular, as illustrated in the drawings, the plurality of rollers 10 and 30 may include one main roller 10 and two adjusting rollers 30 and may be disposed such that a center of rotation forms an inverted triangle.

As such, when the plurality of rollers 10 and 30 include the main roller 10 and the two adjusting rollers 30, the plurality of rollers 10 and 30 may be disposed in an inverted triangle structure such that the specimen 1 may be transported and cut in a direction of gravity.

In this case, the specimen 1 may be an ingot with a large size, such as a silicon substrate, sapphire substrate, quartz substrate, or silicon part used in a semiconductor process, and may be cut to form a wafer in the form of a thin plate-like disk.

The specimen transporter 2 is an equipment for holding the specimen 1 and transporting the specimen 1 to the cutting wire 50 in order to cut the specimen 1, and a detailed description thereof will be omitted.

The cutting apparatus according to the present disclosure includes a controller 100 that controls at least one sub-motor 40 such that the surface speeds of the main roller 10, which rotates the cutting wire 50, and the at least one adjusting roller 30 are the same or substantially the same as each other.

The surface speed of the main roller 10 may refer to a speed at which the main roller 10 rotates the cutting wire 50, and the surface speed of the adjusting roller 30 may refer to a speed at which the adjusting roller 30 rotates the cutting wire 50.

In addition, when the surface speed of the main roller 10 and the surface speed of at least one adjusting roller 30 are not the same or not substantially the same, some sections of the cutting wire 50 become tense or vibration occurs in the cutting wire 50, and some of the main motor 20 and at least one sub-motor 40 have larger loads, while others have smaller loads.

In this case, a relatively large load on the motors 20 and 40 indicates that an output torque is relatively large, and indicates that it is difficult for the motors 20 and 40 to rotate the cutting wire 50 and a relatively large force is required.

In addition, if the motors 20 and 40 require a relatively large force to rotate the cutting wire 50, this may indicate that the surface speed of the rollers 10 and 30 connected to the motors 20 and 40 is relatively high.

Therefore, the controller 100 may recognize that the surface speed of the rollers 10 and 30 connected to the motor with a relatively large output torque is high, and may reduce an applied current to lower the speed of the motor with the relatively large output torque.

Conversely, a relatively small load on the motors 20 and 40 indicates that the output torque is relatively small, indicates that there is no difficulty in rotating the cutting wire 50 and a relatively small force is required, and may indicate that the surface speed of the rollers 10 and 30 connected to the motors is relatively slow.

Therefore, the controller 100 may recognize that the surface speed of the rollers 10 and 30 connected to the motor with a relatively small output torque is slow, and may increase an applied current to increase the speed of the motor with the relatively small output torque.

When initially driving the main motor 20 and at least one sub-motor 40, the controller 100 may control the main motor 20 and at least one sub-motor 40 at the same or substantially the same initial command speed.

When the output torque of the sub-motor 40 for the initial command speed is smaller or greater than the output torque of the main motor 20 for the initial command speed, the controller 100 may determine that the diameters of the main roller 10 and the adjusting roller 30 are different from each other, and control the sub-motor 40 at a changed command speed.

That is, since the output torques of the main motor 20 and the sub-motor 40 are not the same or not substantially the same when the main motor 20 and the sub-motor 40 are controlled at the same or substantially the same initial command speed, the controller 100 may determine that the diameters of the main roller 10 and the adjusting roller 30 connected to each of the main motor 20 and the sub-motor 40 are different from each other.

In addition, the controller 100 may control the sub-motor 40 at the changed command speed in order to control the surface speeds of the main roller 10 and the adjusting roller 30 to be the same or substantially the same.

The changed command speed may be faster or slower than the initial command speed, and may be set by comparing the output torque of the main motor 20 and the output torque of the sub-motor 40.

That is, when the output torque of the sub-motor 40 is greater than the output torque of the main motor 20, the sub-motor 40 may be controlled at a changed command speed that is slower than the initial command speed.

In addition, when the output torque of the sub-motor 40 is smaller than the output torque of the main motor 20, the sub-motor 40 may be controlled at a changed command speed that is faster than the initial command speed.

In this case, the controller 100 may include a compensation controller 110 that calculates the changed command speed, and the compensation controller 110 may calculate a compensation speed value for the output torque of the sub-motor 40 to follow the output torque of the main motor 20, and may calculate the changed command speed by adding or subtracting the compensation speed value to or from the initial command speed value.

The compensation speed value may be calculated using a separate formula or calculated from data through repeated experiments.

In addition, when the output torque of the sub-motor 40 is greater than the output torque of the main motor 20, the compensation controller 110 may obtain the changed command speed value by subtracting the compensation speed value from the initial command speed value.

In addition, when the output torque of the sub-motor 40 is smaller than the output torque of the main motor 20, the compensation controller 110 may obtain the changed command speed value by adding the compensation speed value to the initial command speed value.

In addition, the compensation controller 110 may provide (e.g., feed back) the changed command speed to the sub-motor 40 such that the output torque of the sub-motor 40 becomes the same or substantially the same as the output torque of the main motor 20.

In addition, the compensation controller 110 controls the output torque of the sub-motor 40 to follow the output torque of the main motor 20 by feeding back the changed command speed to the sub-motor 40 until the output torque of the sub-motor 40 becomes the same or substantially the same as the output torque of the main motor 20.

When the task of precisely measuring sizes of the main roller 10 and at least one adjusting roller 30 is added, the controller 100 may control the speeds of the main motor 20 and at least one sub-motor 40 to be different from each other depending on the sizes measured during initial driving.

That is, when the main roller 10 and the at least one adjusting roller 30 are formed to have different diameters, and it is possible to precisely measure a portion where the cutting wire 50 of the main roller 10 is wound and a portion where the cutting wire 50 of the adjusting roller 30 is wound, respectively, the controller 100 may control the main motor 20 and the sub-motor 40 at different speeds from the beginning.

Alternatively, the controller 100 may control the main motor 20 and the sub-motor 40, respectively, such that the surface speeds of the main roller 10 and the at least one adjusting roller 30 become the same or substantially the same as each other without comparing the output torques of the main motor 20 and the sub-motor 40.

That is, when the diameter of the adjusting roller 30 is greater than the diameter of the main roller 10, the controller 100 may control the sub-motor 40 connected to the adjusting roller 30 at the changed command speed that is slower than the command speed of the main motor 20.

In addition, when the diameter of the adjusting roller 30 is smaller than the diameter of the main roller 10, the controller 100 may control the sub-motor 40 connected to the adjusting roller 30 at the changed command speed that is faster than the command speed of the main motor 20.

In addition, when the diameter of the adjusting roller 30 is the same or substantially the same as the diameter of the main roller 10, the controller 100 may control the sub-motor 40 connected to the adjusting roller 30 at the same or substantially the same speed as the command speed of the main motor 20.

Referring to FIG. 3, a control method of a cutting apparatus using a multi-wire according to an embodiment of the present disclosure may include operation S100 of configuring a main motor 20 rotating a main roller 10, at least one sub-motor 40 each rotating at least one adjusting roller 30, and a plurality of cutting wires 50 wound around the main roller 10 and the at least one adjusting roller 30, operation S200 of controlling the main motor 20 and at least one sub-motor 40 at an initial command speed, and operation S300 of controlling a speed of at least one sub-motor 40 such that surface speeds of the main roller 10 and the at least one adjusting roller 30 become the same or substantially the same.

In the control method of the cutting apparatus using the multi-wire according to the present disclosure, operation S100 of configuring the main roller 10, at least one adjusting roller 30, and a plurality of cutting wires 50 may be performed.

The main roller 10 and at least one adjusting roller 30 of different diameters may be installed, or even if being installed with the same or substantially the same diameter, the main roller 10 and at least one adjusting roller 30 may be installed with slightly different diameters due to machining errors.

Next, operation S200 of controlling the main motor 20 and at least one sub-motor 40 at the initial command speed is performed. The initial command speed is the speed input to suit a desired cutting force and may be adjusted according to an operator's input.

When the main motor 20 and at least one sub-motor 40 are controlled at the initial command speed, a difference may occur in the surface speeds of the main motor 20 and at least one sub-motor 40 due to a difference in diameter between the main roller 10 and the at least one adjusting roller 30 each connected to the main motor 20 and the at least one sub-motor 40.

Accordingly, operation S300 of controlling the speed of at least one sub-motor 40 such that the surface speeds of the main roller 10 and the at least one adjusting roller 30 become the same or substantially the same is performed.

Referring to FIG. 4, operation S310 of checking whether there is a difference between an output torque of the main motor 20 and an output torque of the sub-motor 40 is performed.

If the output torque of the sub-motor 40 is the same or substantially the same as the output torque of the main motor 20, the controller 100 may determine that the surface speeds of the main roller 10 and at least one adjusting roller 30 connected to the main motor 20 and the sub-motor 40 are at the same or substantially the same level, and may perform an operation of controlling the initial command speed without changing the speed of the sub-motor 40.

In addition, when the main motor 20 and the at least one sub-motor 40 are controlled at the same or substantially the same speed by applying the same or substantially the same current to the main motor 20 and the at least one sub-motor 40, the surface speeds of the main roller 10 and the at least one adjusting roller 30 connected to the main motor 20 and the at least one sub-motor 40 are the same or substantially the same. Therefore, the controller 100 may determine that the diameters of the main roller 10 and the at least one adjusting roller 30 are the same or substantially the same.

Conversely, if the output torque of the sub-motor 40 for the initial command speed is different from the output torque of the main motor 20 for the initial command speed, the controller 100 may determine that the diameters of the main roller 10 and the adjusting roller 30 are different from each other.

Next, if there is a difference between the output torque of the main motor 20 and the output torque of the sub-motor 40, operation S320 of controlling the sub-motor 40 at the changed command speed may be performed.

Specifically, in operation S320 of controlling the sub-motor 40 at the changed command speed, if the output torque of the sub-motor 40 is greater than the output torque of the main motor 20, the sub-motor 40 is controlled at a changed command speed that is slower than the initial command speed.

In addition, if the output torque of the sub-motor 40 is smaller than the output torque of the main motor 20, the sub-motor 40 is controlled at a changed command speed that is faster than the initial command speed.

Next, whether the output torque of the sub-motor 40 is the same or substantially the same as the output torque of the main motor 20 is determined in operation S330. If the two output torques are the same or substantially the same, the operation of controlling the speed of at least one sub-motor 40 such that the surface speeds of the main roller 10 and the at least one adjusting roller 30 become the same or substantially the same may be completed.

On the other hand, if the output torque of the sub-motor 40 is not the same or substantially the same as the output torque of the main motor 20, operations S320 and S330 may be repeated by comparing the magnitudes of the output torque of the sub-motor 40 and the output torque of the main motor 20 and changing the changed command speed again.

In addition, operation S320 of controlling the sub-motor 40 at the changed command speed may include an operation of calculating a compensation speed value for the output torque of the sub-motor 40 to follow the output torque of the main motor 20, and calculating a changed command speed by adding or subtracting the compensation speed value to or from the initial command speed value.

After the changed command speed is calculated as described above, an operation of providing (e.g., feeding back) the changed command speed to the sub-motor 40 such that the output torque of the sub-motor 40 becomes the same or substantially the same as the output torque of the main motor 20 may be performed.

In addition, whether the output torque of the sub-motor 40 is the same or substantially the same as the output torque of the main motor 20 is determined in operation S330, and if the two output torques are the same or substantially the same, the feedback task may be completed and the sub-motor 40 may be continuously controlled at the changed command speed that was finally fed back.

On the other hand, if the output torque of the sub-motor 40 is not the same or substantially the same as the output torque of the main motor 20, the operation of providing (e.g., feeding back) the changed command speed to the sub-motor 40 may be repeatedly performed.

When the task of precisely measuring sizes of the main roller 10 and at least one adjusting roller 30 is added, the controller 100 may control the speeds of the main motor 20 and at least one sub-motor 40 to be different from each other depending on the sizes measured during initial driving.

That is, in operation S100, the main roller 10 and at least one adjusting roller 30 having different diameters are configured, and the diameters of the main roller 10 and at least one adjusting roller 30 are precisely measured.

In addition, in operation S320 of controlling the speed of at least one sub-motor 40, if the diameter of the adjusting roller 30 is greater than the diameter of the main roller 10, the sub-motor 40 connected to the adjusting roller 30 may be controlled at the changed command speed that is slower than the command speed of the main motor 20.

In addition, in operation S320 of controlling the speed of at least one sub-motor 40, if the diameter of the adjusting roller 30 is smaller than the diameter of the main roller 10, the sub-motor 40 connected to the adjusting roller 30 may be controlled at the changed command speed that is faster than the command speed of the main motor 20.

According to the embodiments of the present disclosure, the cutting apparatus may include at least three or more rollers and thus cut an ingot having a large volume and may use small-sized rollers and thus reduce a load applied to a motor connected to the rollers.

Further, since the motor may be connected to one roller and the plurality of rollers may independently rotate, the load applied to the motor may be reduced and the speeds of the plurality of rollers may be individually controlled.

Further, since the wire may be rotated at the same or substantially the same speed even if diameters of the plurality of rollers are different, a load on a motor may be reduced, and vibration and damage to the cutting wire may be thus minimized to efficiently operate the equipment.

In particular, a high cutting force may be provided by increasing a linear speed of the wire as the wire stably rotates.

Various embodiments as set forth herein may be implemented as software including one or more instructions that are stored in a storage medium that is readable by a machine. For example, a controller of the machine may invoke at least one of the one or more instructions stored in the storage medium, and execute it, with or without using one or more other components under the control of the controller. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like (collectively “devices”) represented by a block or an equivalent indication in the above embodiments including, but not limited to, the “controller 100” and the “compensation controller 110” in FIG. 2, may be physically implemented by analog and/or digital circuits including one or more of a logic gate, an integrated circuit, a microprocessor, a microcontroller such as a central processing unit (CPU), a memory circuit, a passive electronic component, an active electronic component, an optical component, and the like, and the functions or operations of the devices may be implemented by or driven by software and/or firmware executed by the devices.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A cutting apparatus comprising:
a main roller;
a main motor configured to rotate the main roller;
a plurality of adjusting rollers spaced apart from the main roller;
a plurality of sub-motors respectively connected to the plurality of adjusting rollers and configured to respectively rotate the plurality of adjusting rollers;
a plurality of cutting wires wound around the main roller and the plurality of adjusting rollers; and
a controller configured to control the main motor and the plurality of sub-motors such that a surface speed of the main roller is substantially the same as surface speeds of the plurality of adjusting rollers.

2. The cutting apparatus of claim 1, wherein the controller is further configured to control the main motor and the plurality of sub-motors at an initial command speed.

3. The cutting apparatus of claim 2, wherein, based on an output torque of at least one of the plurality of sub-motors corresponding to the initial command speed being smaller or greater than an output torque of the main motor corresponding to the initial command speed, the controller is configured to control the at least one of the plurality of sub-motors at a changed command speed.

4. The cutting apparatus of claim 3, wherein, based on the output torque of the at least one of the plurality of sub-motors being greater than the output torque of the main motor, the changed command speed is slower than the initial command speed, and
wherein, based on the output torque of the at least one of the plurality of sub-motors being smaller than the output torque of the main motor, the changed command speed is faster than the initial command speed.

5. The cutting apparatus of claim 3, wherein the controller comprises a compensation controller configured to:
determine a compensation speed value for the output torque of the at least one of the plurality of sub-motors; and
determine the changed command speed by adding or subtracting the compensation speed value to or from the initial command speed.

6. The cutting apparatus of claim 5, wherein the compensation controller is further configured to provide the changed command speed to the at least one of the plurality of sub-motors such that the output torque of at least one of the plurality of sub-motors becomes substantially the same as the output torque of the main motor.

7. The cutting apparatus of claim 3, wherein, based on the output torque of the at least one of the plurality of sub-motors corresponding to the initial command speed being smaller or greater than the output torque of the main motor corresponding to the initial command speed, the controller is configured to determine that a diameter of the main roller is different from a diameter of at least one of the plurality of adjusting rollers.

8. The cutting apparatus of claim 1, wherein the main roller and at least one of the plurality of adjusting rollers have different diameters.

9. The cutting apparatus of claim 8, wherein, based on a diameter of at least one of the plurality of adjusting rollers being greater than the diameter of the main roller, the controller is configured to a sub-motor of the plurality of sub-motors connected to the at least one of the plurality of adjusting rollers at a changed command speed that is slower than a command speed of the main motor, and
wherein, based on the diameter of the at least one of the plurality of adjusting rollers being smaller than the diameter of the main roller, the controller is configured to control the sub-motor connected to the at least one of the plurality of adjusting rollers at a changed command speed that is faster than the command speed of the main motor.

10. The cutting apparatus of claim 1, wherein the plurality of adjusting rollers comprises two adjusting rollers, and
wherein the main roller and the two adjusting rollers are disposed such that a center of rotation of the main roller and the two adjusting rollers forms an inverted triangle.

11. A control method of a cutting apparatus, the cutting apparatus comprising a main roller, a main motor configured to rotate the main roller, a plurality of adjusting rollers, a plurality of sub-motors configured to respectively rotate the plurality of adjusting rollers, and a plurality of cutting wires wound around the main roller and the plurality of adjusting rollers, the control method comprising:
controlling the main motor and the plurality of sub-motors at an initial command speed; and
controlling speeds of the plurality of sub-motors such that a surface speed of the main roller is substantially the same as surface speeds of the plurality of adjusting rollers.

12. The control method of claim 11, wherein the controlling the speeds of the plurality of sub-motors comprises:
comparing an output torque of the main motor and an output torque of at least one of the plurality of sub-motors; and
controlling the at least one of the plurality of sub-motors at a changed command speed based on the output torque of the at least one of the plurality of sub-motors being different from the output torque of the main motor.

13. The control method of claim 12, wherein the controlling the speeds of the plurality of sub-motors further comprises controlling the at least one of the plurality of sub-motors at the initial command speed based on the output torque of the at least one of the plurality of sub-motors being substantially the same as the output torque of the main motor.

14. The control method of claim 12, wherein, based on the output torque of the at least one of the plurality of sub-motors being greater than the output torque of the main motor, the changed command speed is slower than the initial command speed, and
wherein, based on the output torque of the at least one of the plurality of sub-motors being smaller than the output torque of the main motor, the changed command speed is faster than the initial command speed.

15. The control method of claim 12, wherein the controlling of the at least one of the plurality of sub-motors at the changed command speed comprises:
determining a compensation speed value for the output torque of the at least one of the plurality of sub-motors; and
determining the changed command speed by adding or subtracting the compensation speed value to or from the initial command speed.

16. The control method of claim 15, wherein the controlling of the at least one of the plurality of sub-motors at the changed command speed further comprises providing the changed command speed to the at least one of the plurality of sub-motors such that the output torque of the at least one of the plurality of sub-motors becomes substantially the same as the output torque of the main motor.

17. The control method of claim 12, wherein the comparing the output torque of the main motor and the output torque of the at least one of the plurality of sub-motors comprises:
based on the output torque of the at least one of the plurality of sub-motors corresponding to the initial command speed being smaller or greater than the output torque of the main motor corresponding to the initial command speed, determining that a diameter of the main roller is different from a diameter of at least one of the plurality of adjusting rollers.

18. The control method of claim 11, wherein the main motor, the plurality of sub-motors, and the plurality of cutting wires, the main roller and the plurality of adjusting rollers have different diameters.

19. The control method of claim 18, wherein the controlling of speeds of the plurality of sub-motors comprises:
based on a diameter of the at least one of the plurality of adjusting rollers being greater than a diameter of the main roller, controlling a sub-motor of the plurality of sub-motors connected to the at least one of the plurality of adjusting rollers at a changed command speed that is slower than a command speed of the main motor; and
based on the diameter of the at least one of the plurality of adjusting rollers being smaller than the diameter of the main roller, controlling the sub-motor of the plurality of sub-motors connected to the at least one of the plurality of adjusting rollers at a changed command speed that is faster than the command speed of the main motor.
